(19) United States
(12) Patent Application Publication
(10) Pub. No.: US 2005/0079311 A1
(43) Pub. Date: Apr. 14, 2005

(54) Furniture having a patchwork appearance

(76) Inventor: Hi Thomas Keller, High Point, NC (US)

Correspondence Address: WOMBLE CARLYLE SANDRIDGE & RICE PLLC, 300 N. GREENE STREET, SUITE 1900, GREENSBORO, NC, 27401, US

(21) Appl. No.: 10/684,944

(22) Filed: Oct. 14, 2003

(51) Int. Cl. B32B 3/14

(52) U.S. Cl. 428/50

(57) ABSTRACT

A wooden panel for use in casegood furniture fronts to create a patchwork appearance. A background is formed from at least one wood grain type, and a pattern is formed of at least two contrasting woods of a second wood grain type. The background and pattern are so adjoined that the pattern creates a repeatable patchwork appearance against the background.

### FIELD OF THE INVENTION

The present invention relates to ornamental furniture design, and more particularly, to a method for creating a patchwork appearance on items of casegood furniture fronts.

### BACKGROUND OF THE INVENTION

For centuries, wood has been the recognized and sought after material of choice for the construction of furniture. Although wood was an inexpensive material of construction for many years, the scarcity of most hardwoods has now made wooden furniture more expensive, particularly for selected hardwoods.

Over the years, furniture manufacturers have endeavored to create unique, rich-looking furniture collections that are appealing to a large number of buyers. Manufacturers have thus created price and quality ranges for home furnishings for nearly every price point in the market. Present-day manufacturers recognize the demand for expensive looking, yet lower priced furnishings and have sought to develop methods for creating new furniture that incorporates hardwoods into the surfaces of the furniture. For example, some manufacturers have chosen to affix hardwood veneers to furniture surfaces such as table tops, head and footboards for beds, etc. Where this has been done, however, the veneers have been either single pieces of one wood type, or have been limited to two different wood grain types that are arranged in a uniform pattern and alignment.

An additional dilemma for furniture manufacturers has been the significant popularity of some furniture designs/collections, while others have had disappointing results. Unfortunately, the designs that are most appealing to a large number of buyers are only available in a particular price range; i.e., the furniture is either too expensive for many buyers because it is constructed of solid, rigid, hardwoods, or is partially constructed of veneers at a low price point, which does not appeal to those buyers who always purchase at the highest, or premium, quality level. Thus, despite its popularity, sales of a particular design are limited to the buyers at the particular price point at which the furniture is constructed and priced.

Yet another challenge facing furniture manufacturers is the creation of designs that will appeal to a wide range of prospective buyers. Thus, manufacturers are constantly looking for unique designs that set the furniture apart from their competitors. What is needed, therefore, is an ornamental furniture design that appeals to a large population of potential buyers, yet creates a unique image or pattern that is not typical of wooden furniture.

### SUMMARY OF THE INVENTION

The present invention relates, in part, to a decorative panel for use in casegood furniture fronts, and the resulting furniture formed therewith, that creates an appearance that is not typically formed in wood grains.

A first aspect of the present invention is directed to a decorative wooden panel for use in furniture to create a patchwork appearance. The panel includes a background portion and a pattern. The background portion is formed from a background wood grain type such as, but not limited to, birdseye maple. Birdseye maple has a unique pattern and texture that creates a “fabric-looking” background.

A pattern for the panel is formed of at least two contrasting woods of a pattern wood grain type, each contrasting with the wood grain type of the background. The pattern is desirably selected from well known and popular quilt patterns. For instance, it has been found that the Cathedral Windows and Double Wedding Ring quilt patterns are exemplary of the more famous patterns can be simulated with such woods as mahogany, maple, cherry, and prima vera.

As will be discussed in greater detail below, there are various ways to form the panel of the present invention. The wooden panel comprising the background and the pattern may be constructed by adjoining solid, rigid wooden pieces, boards, or slats. In a second type of construction, the background and pattern of the wooden panel may be formed of relatively thin, flexible veneer pieces to form a wooden sheet that is subsequently adhered to a rigid substrate. Lastly, the panel may be constructed as a sheet material that is adhered to a substrate. For example, the sheet material may be a decal produced from high quality digital images that depict the same wood grain types as an actual wooden (rigid or veneer) construction.

A further aspect of the present invention is directed to an article of furniture that incorporates the panel of the present invention therein. For instance, the panel can be shaped and dimensioned to form the front of casegood furniture, such as a drawer or door front, or the headboard or footboard of a bed.

This and other aspects of the present invention will become apparent to those skilled in the art after a reading of the following description of the preferred embodiments when considered in conjunction with the drawings. It should be understood that both the foregoing general description and the following detailed description are exemplary and explanatory only and are not restrictive of the invention as claimed.

### BRIEF DESCRIPTION OF THE DRAWINGS

FIG. 1 is a front view of the Cathedral Windows Quilt design;

FIG. 2 is a front view of the Double Wedding Ring Quilt design;

FIG. 3 is a front view of the Star Quilt design;

FIG. 4 is a perspective view of a decal formed according to the present invention;

FIG. 5 is an exploded perspective view illustrating the components of a veneer or decal panel construction; and

FIGS. 6 through 8 are front elevation views of articles of furniture having front surfaces formed with the panels of the present invention incorporated therein.

### DETAILED DESCRIPTION OF THE PREFERRED EMBODIMENTS

The present invention is directed to a method for creating casegood furniture fronts, or panels, having a quilted patchwork appearance, as well as the furniture that incorporates the panels. As used herein, “casegoods” refers to hard-surfaced, and not upholstered, furniture. Also, as used herein, the term “patchwork” refers to various patches or pieces of material sewn together, or adhered to the surface of an underlying material, as in a quilt, to form one or more patterns.

For generations, individuals have been creating hand-sewn patchwork quilts for use as decorative bedding. While many quilts are uniquely formed with individual-specific designs, there are numerous quilt patterns that have become so popular over the years that they have been both copied, or modified to individual tastes by various color schemes and border designs.

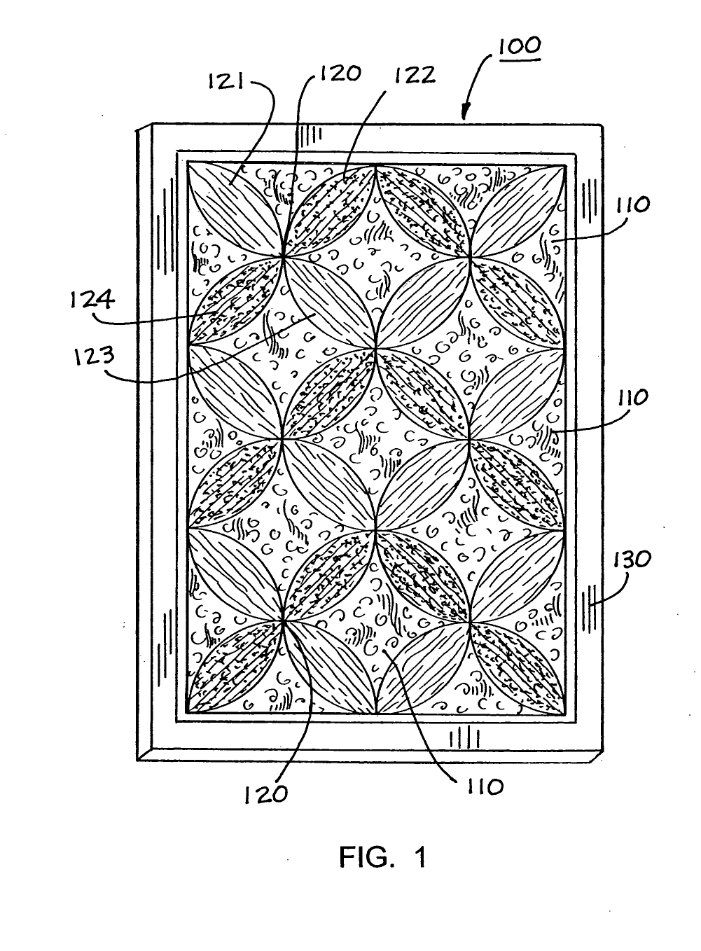

Turning now to FIGS. 1 through 3, three exemplary popular quilt designs are shown that have been constructed according to the present invention; however, there are many well-known designs that could be constructed according to the present invention. Referring first to FIG. 1, the quilt design depicted is commonly known as the Cathedral Window pattern. Shown generally as 100, the quilt design comprises a background 110 and at least one repeatable pattern 120. As will be explained in greater detail below, the background 110 is formed from a first, or background, wood grain type. As used herein, “wood grain” refers to the arrangement, direction, or pattern of the fibrous tissue in wood. To create a “fabric-like” quilted appearance, the wood forming the background has a grainy or spotted appearance. One suitable wood for the background is birdseye maple, although other woods having a similar type of, or unique, grain may also be used. Birdseye maple is particularly suitable because of its irregular spotted grain. Alternatively, however, numerous other wood types may be used.

The pattern 120 is formed from at least two contrasting woods of a second, or pattern, wood grain type such as mahogany, maple, cherry, and prima vera. In the Cathedral Window pattern, the pattern 120 is formed as four leaves 121, 122, 123, and 124. As shown in FIG. 1, leaves 121 and 123 are formed from mahogany, while leaves 122 and 124 are formed from prima vera (while mahogany). Other woods for the pattern are the maples and cherries. As will be appreciated, the four leaves could be formed from three or four different contrasting woods, if desired. Regardless of the number chosen for the leaves 121, 122, 123, and 124, each of the woods forming the pattern 120 are selected to contrast with the first wood type grain forming the background 110. This creates a repeatable quilted patchwork appearance against the background 110. Optionally, the quilt design 100 may include a border 130 which is also a contrasting wood.

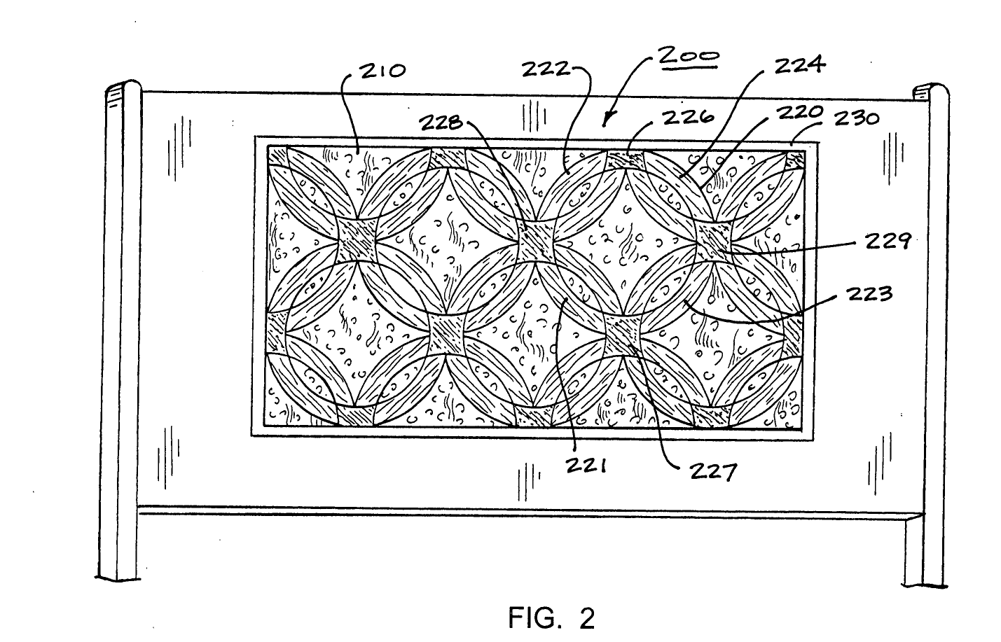

Referring now to FIG. 2, the second exemplary quilt design is known as the Double Wedding Ring design. Shown generally as 200, this quilt design also comprises a background 210 and at least one repeatable design 220. Again, the background 210 is formed from a wood type such as birdseye maple that gives the background a fabric-like appearance when viewed from a distance. The repeatable pattern 220 comprises ring segments 221 through 224 which are formed of a wood grain type that contrasts with the grain type of the background. The points of intersection of the ring segments of adjoining patterns are represented by segments 226 through 229. The segments 226 through 229 may be formed from a wood that is contrasting with both the background 210 and the ring segments 221 through 224. An optional border 230 may also be constructed of a fourth contrasting wood.

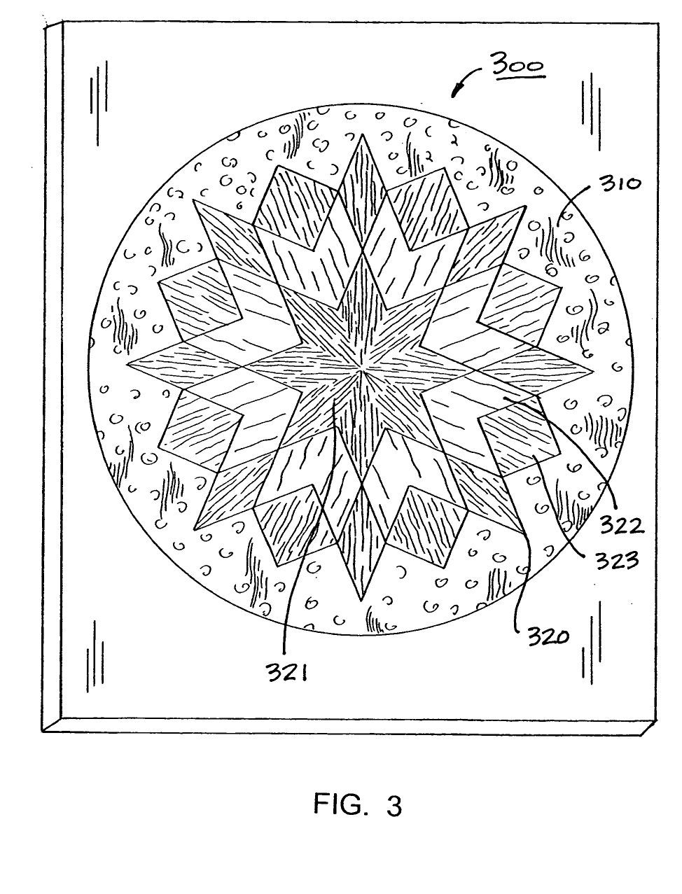

Referring to FIG. 3, a third exemplary Star quilt design is shown. Shown generally as 300, this exemplary star pattern also comprises a background 310 and at least one repeatable pattern 320. Also again, the background 310 is formed of a wood type that creates a fabric-like appearance when viewed from a distance. The repeatable star pattern 320 comprises at least two segments. As shown in FIG. 3, the repeatable pattern 320 comprises three star segments 321 through 323. Each of the star segments is formed of a different contrasting wood type or wood grain type that also contrasts with the background wood grain type 310.

One aspect of the present invention is directed to a wooden panel for use in furniture to create a patchwork appearance. In the preferred embodiment, the patchwork designs are initially formed from wooden veneer sheets. As used herein, “veneer” refers to a thin layer of wood or other material for forming the facing or an inlay of a useful article, such as an item of furniture. Veneer sheets have been used for many years to form the outer coverings, or surfaces, of many different items of furniture.

As described above, it has been found that birdseye maple, mahogany, cherry, maple, and prima vera are particularly suitable. Birdseye maple is particularly suitable for the background portion of the veneer sheet since it has a texture that looks much like a fabric when viewed from a distance; however, other wood types having a similar wood grain type or appearance may also be used. For birdseye maple, the unique grain is the result of buds that are unable to force their way through the bark to the tree surface. Mahogany has also been a popular choice for decades for cabinet making. While there are three general types of mahogany African mahogany has been found quite suitable. Alternatively, cherry and prima vera provide suitable contrasting wood grains. In the present invention, the starting sheets for forming the background and repeatable pattern portions are approximately 0.040 inches thick; however, this dimension, while common in the furniture industry, is not critical to the present invention.

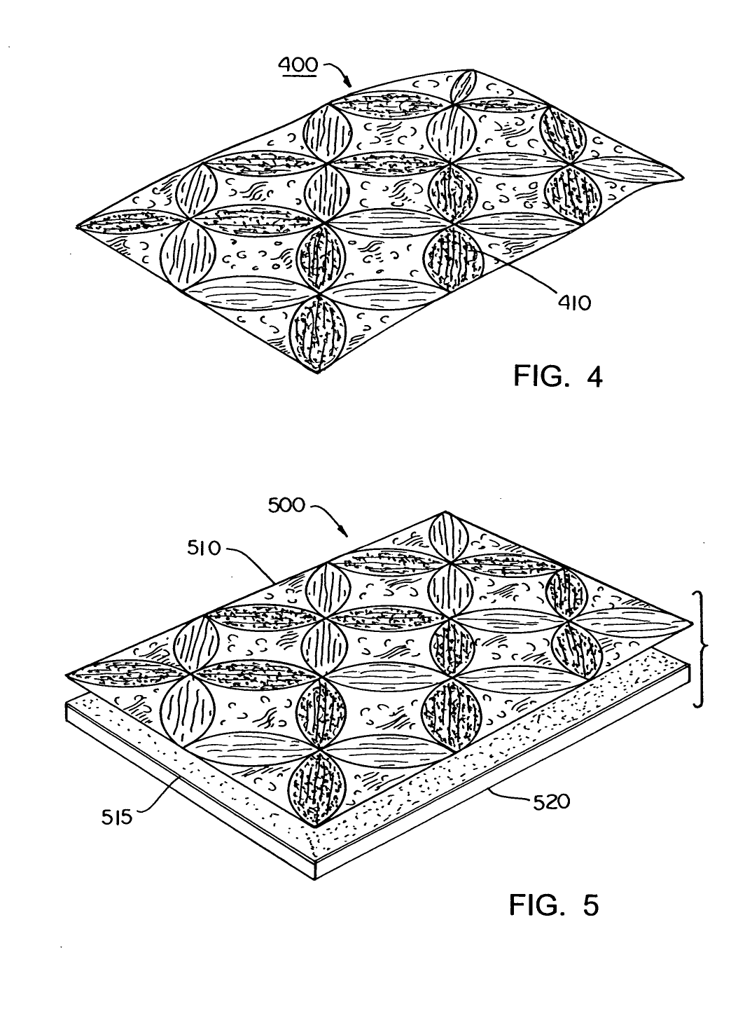

To form the quilt patterns, the background and pattern pieces are first cut to the desired shapes from the veneer sheets and adjoined to form a complete quilt pattern. In one preferred embodiment, once the quilt pattern is completed, digital photographic images are taken of the quilt pattern. The digital images are then edited on a personal computer to color the wood grain types, if desired. One software that is suitable for processing such digital images is Adobe® Photoshop®. The edited images for each quilt pattern are then saved. The edited images are then transferred to a sheet material producer, where the high quality digital images are used to produce large, high quality decals, such as the one shown as 400 in FIG. 4 with the Cathedral Window pattern 410 formed thereon. One producer of such decals is Cranford Silkscreen Processes of High Point, N.C. The furniture manufacturer applies the decals to a substrate material such as plywood. A panel is thus formed which can be incorporated into a piece of furniture as a door or drawer front, or headboard or footboard of a bed. Conventional furniture finishes may next be applied to the furniture and over the decal, wherein the panel with the decal applied thereto appears to be formed of real wood. decals. The result is a lower-priced piece of furniture.

A second embodiment of the present invention is directed to a wooden panel and furniture incorporating the wooden panel that will satisfy a high price point in the market. The veneer quilt design if formed in the same way as in the first embodiment, however, the actual veneer is used in the panel construction. Once the wooden quilt is assembled, it is ready to be adhered to a substrate that will form the principal structural element for incorporation into an article of furniture. As seen in FIG. 5, the components of the panel 500, such as a door face, are schematically illustrated. A thin veneer quilt design 510, constructed as described hereinabove, is adhered to a substrate 520. Two suitable substrates 520 for the construction are plywood and particleboard. The substrate 520 is first prepared for receiving the veneer quilt 510 by applying an adhesive 515 to the entire surface. The adhesive used for this application is a resin-based glue formed from a resin and catalyst mixture. Such resin-based glues are readily commercially available and widely known in the furniture industry. The veneer quilt pattern 510 is next affixed to the substrate over the glue.

Upon curing, the finished furniture panel 80 is ready for incorporation into a larger furniture piece, and subsequent finishing with stains and protective coverings, as desired, and as are well known in the art. As used herein, “furniture piece” refers, but is not limited to tables, beds, cabinets, dressers, chests, etc. having at least one exposed face.

In a third embodiment of the present invention, the wooden panel may be constructed entirely of hardwoods that are cut from thicker wooden pieces, boards, or slats. The cut pieces forming the background and pattern are then adhered together along their peripheral edges to complete the wooden panel construction.

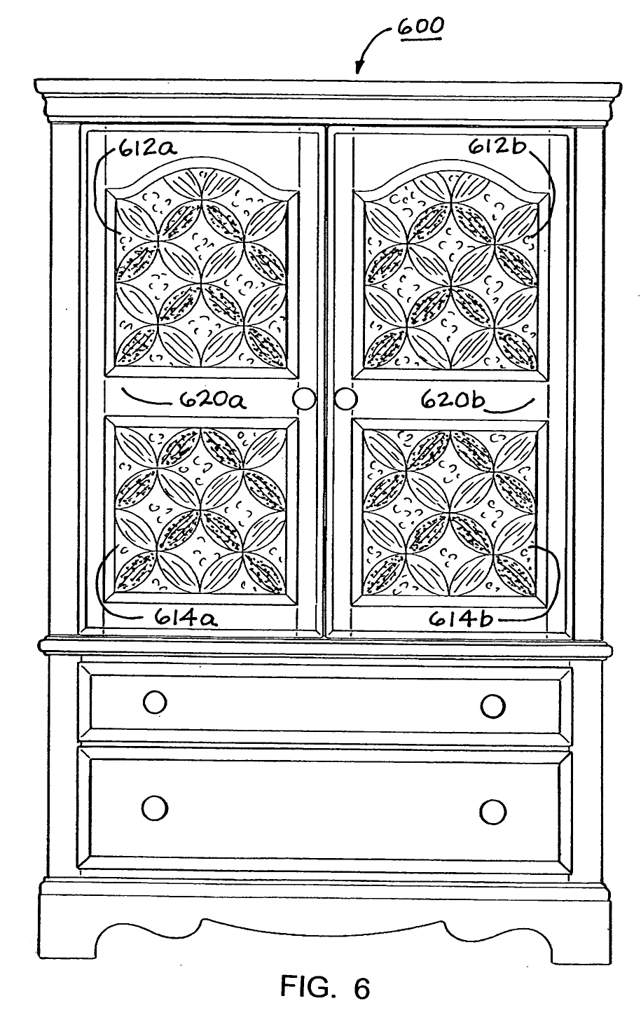

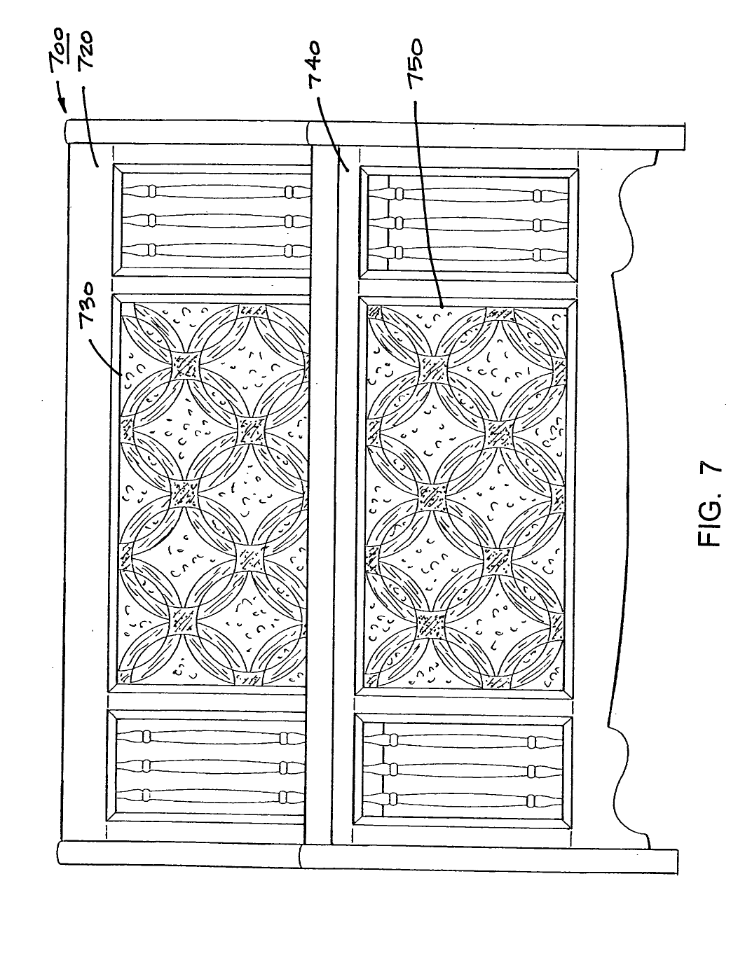

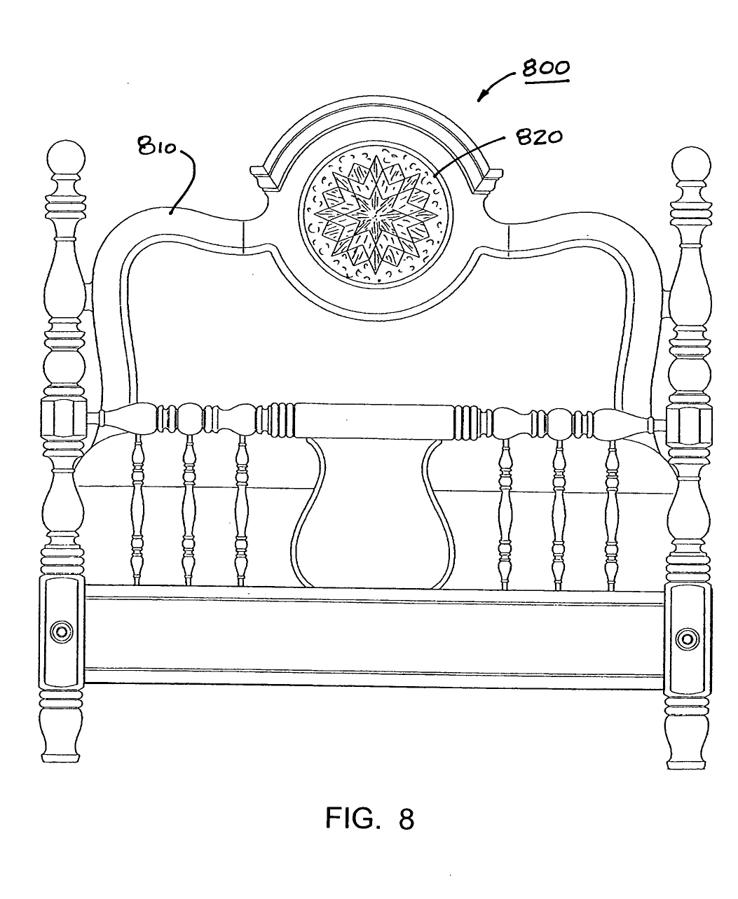

Turning now to FIGS. 6 through 8, exemplary furniture pieces are shown that incorporate the above-described exemplary quilt patterns. In FIG. 6, a chest 600 includes doors 620a and 620b that each incorporate panels 612 and 614 having the repeatable Cathedral Window quilt pattern. As those skilled in the art will appreciate, the panels 612 and 614 may be framed within the doors 620 by the door trim, moulding, door channels, etc. FIG. 7 is exemplary of a bed 700 wherein both the headboard 720 and footboard 740 incorporate panels 730 and 750, respectfully, having the repeatable Double Wedding Ring quilt pattern. Lastly, FIG. 8 is exemplary of another bed type 800 that incorporates a panel 820 having the repeatable star quilt pattern into the headboard 810.

Although the present invention has been described with preferred embodiments, it is to be understood that modifications and variations may be utilized without departing from the spirit and scope of this invention, as those skilled in the art will readily understand. Such modifications and variations are considered to be within the purview and scope of the appended claims and their equivalents.

1. A wooden panel for use in casegood furniture fronts to create a patchwork appearance comprising:
(a) a background formed from at least one wood grain type; and
(b) a pattern formed of at least two contrasting woods of a second wood grain type, wherein the background and pattern are so adjoined that the pattern creates a repeatable patchwork appearance against the background.

2. The wooden panel of claim 1 wherein the at least one wood grain type of the background and the at least two contrasting woods of the second wood grain type of the pattern are veneer.

3. The wooden panel of claim 2 wherein:
(a) the at least one wood grain type of the background is selected from the group consisting of birdseye maple and wood grains similar thereto; and
(b) the at least two contrasting wood grain types of the second wood grain type of the pattern are selected from the group of wood grain types consisting of mahogany, maple, cherry, and prima vera.

4. The wooden panel of claim 1 wherein the pattern is a cathedral window quilt pattern.

5. The wooden panel of claim 1 wherein the pattern is a double wedding ring pattern.

6. The wooden panel of claim 1 wherein the pattern is star-shaped.

7. A wooden panel door front, drawer front, or headboard having a patchwork appearance for incorporation into an article of furniture, said panel comprising:
(a) a substrate;
(b) a wooden panel comprising:
(i) a background formed from at least one wood grain type;
(ii) a pattern formed of at least two contrasting woods of a second wood grain type, wherein the background and pattern are so adjoined that the pattern creates a repeatable patchwork appearance against the background; and
(c) wherein the wooden panel is affixed to the substrate.

8. The wooden panel of claim 7 wherein the at least one wood grain type of the background and the at least two contrasting woods of the second wood grain type of the pattern are veneer.

9. The wooden panel of claim 8 wherein:
(a) the at least one wood grain type of the background is selected from the group consisting of birdseye maple and wood grains similar thereto; and
(b) the at least two contrasting wood grain types of the second wood grain type of the pattern are selected from the group of wood grain types consisting of mahogany, maple, cherry, and prima vera.

10. The wooden panel of claim 7 wherein the pattern is a cathedral window quilt pattern.

11. The wooden panel of claim 7 wherein the pattern is a double wedding ring pattern.

12. The wooden panel of claim 7 wherein the pattern is star-shaped.

13. An article of furniture with at least one surface thereof having a patchwork appearance, said article of furniture comprising:
(a) a substrate
(b) a wooden panel, including:
(i) a background formed from at least one wood grain type; and
(ii) a pattern formed of at least two contrasting woods of a second wood grain type, the background and pattern being so adjoined that the pattern creates a repeatable patchwork appearance against the background, wherein the wooden panel is affixed to the substrate; and
(c) a furniture member incorporating therein the substrate with wooden panel affixed thereto.

14. The article of furniture of claim 13 wherein the at least one wood grain type of the background and the at least two contrasting woods of the second wood grain type of the pattern are veneer.

15. The article of furniture of claim 14 wherein:
(a) the at least one wood grain type of the background is selected from the group consisting of birdseye maple and wood grains similar thereto; and
(b) the at least two contrasting wood grain types of the second wood grain type of the pattern are selected from the group of wood grain types consisting of mahogany, maple, cherry, and prima vera.

16. The article of furniture of claim 13 wherein the pattern is a cathedral window quilt pattern.

17. The article of furniture of claim 13 wherein the pattern is a double wedding ring pattern.

18. The article of furniture of claim 13 wherein the pattern is star-shaped.

19. A panel door front, drawer front, or headboard having a patchwork appearance for incorporation into an article of furniture, said panel comprising:
(a) a substrate;
(b) a sheet material comprising:
(i) a background depicting at least one wood grain type;
(ii) a pattern depicting at least two contrasting woods of a second wood grain type, the background and pattern being arranged that the pattern creates a repeatable patchwork appearance against the background; and
(c) wherein the sheet material is affixed to the substrate.

20. The panel of claim 19 wherein the sheet material is a decal.

21. The panel of claim 19 wherein:
(a) the at least one wood grain type of the background is selected from the group consisting of birdseye maple and wood grains similar thereto; and
(b) the at least two contrasting wood grain types of the second wood grain type of the pattern are selected from the group of wood grain types consisting of mahogany, maple, cherry, and prima vera.

22. The panel of claim 19 wherein the pattern is a cathedral window quilt pattern.

23. The panel of claim 19 wherein the pattern is a double wedding ring pattern.

24. The panel of claim 19 wherein the pattern is star-shaped.

25. An article of furniture with at least one surface thereof having a patchwork appearance, said article of furniture comprising:
(a) a substrate
(b) a sheet material, including:
(i) a background depicting at least one wood grain type; and
(ii) a pattern depicting at least two contrasting woods of a second wood grain type, the background and pattern being so arranged that the pattern creates a repeatable patchwork appearance against the background, wherein the sheet material is affixed to the substrate; and
(c) a furniture member incorporating therein the substrate with sheet material affixed thereto.

26. The article of furniture of claim 25 wherein the sheet material is a decal.

27. The article of furniture of claim 25 wherein:
(a) the at least one wood grain type of the background is selected from the group consisting of birdseye maple and wood grains similar thereto; and
(b) the at least two contrasting wood grain types of the second wood grain type of the pattern are selected from the group of wood grain types consisting of mahogany, maple, cherry, and prima vera.

28. The article of furniture of claim 25 wherein the pattern is a cathedral window quilt pattern.

29. The article of furniture of claim 25 wherein the pattern is a double wedding ring pattern.

30. The article of furniture of claim 25 wherein the pattern is star-shaped.
